(19) United States
(12) Patent Application Publication
(10) Pub. No.: US 2017/0142680 A1
(43) Pub. Date: May 18, 2017

(54) TECHNIQUES FOR DETERMINING A DEVICE LOCATION

(71) Applicant: QUALCOMM Incorporated, San Diego, CA (US)

(72) Inventors: Yoseph MALKIN, San Jose, CA (US); Sudheep THOTA, San Jose, CA (US); Xiaoxin ZHANG, Fremont, CA (US)

(21) Appl. No.: 14/942,797

(22) Filed: Nov. 16, 2015

(51) Int. Cl. H04W 64/00

(52) U.S. Cl. CPC H04W 64/00

(57) ABSTRACT

Techniques for determining a device location based on measurements from multiple RATs are described. In an aspect, the methods and apparatus include determining, at a first device, one or more round trip time (RTT) measurements based on one or more signals communicated with a second device over a first Radio Access Technology (RAT). Further, in an aspect, the methods and apparatus include determining, at the first device, one or more angle measurements based on one or more signals communicated with the second device over a second RAT. Additionally, the methods and apparatus include determining a location of the first device in relation to the second device based on the one or more RTT measurements and the one or more angle measurements. The one or more angle measurements may include one or more angle of departure (AoD) measurements, one or more angle of arrival (AoA) measurements, or both.

### BACKGROUND

Aspects of this disclosure relate generally to telecommunications, and more particularly to techniques for determining a device location based on measurements from multiple radio access technologies (RATs).

The deployment of wireless local area networks (WLANs) in the home, the office, and various public facilities is commonplace today. Such networks typically employ a wireless access point (AP) that connects a number of wireless stations (STAs) in a specific locality (e.g., home, office, public facility, etc.) to another network, such as the Internet or the like. A set of STAs can communicate with each other through a common AP in what is referred to as a basic service set (BSS). Nearby BSSs may have overlapping coverage areas and such BSSs may be referred to as overlapping BSSs or OBSSs.

Bluetooth (BT) wireless technology is also commonplace today and is used for allowing standardized exchanges of data over short distances using the industrial, scientific, and medical (ISM) band.

In some wireless communication networks, a device may determine its location (or the location of another device) based on measurements received from multiple reference devices. The device may determine its location for a number of purposes, including, but not limited to, cell selection, application uses, peer-to-peer (P2P) communications, etc. For example, using Round Trip Time (RTT) measurements, a WLAN device (e.g., Wi-Fi device) typically requires the RTT measurement information from at least three other WLAN devices with known two dimensional (2D) locations to compute its own 2D location. Similar to WLAN devices, a Bluetooth device requires information from three other closely placed peer BT devices with known 2D locations for the BT device to compute its own 2D location.

There may be scenarios in which multiple reference devices may not be available within a close proximity of a particular device to obtain the needed information to accurately determine that device's location. Accordingly, it may be desirable to accurately determine a device's location based on information provided by the fewest number of reference devices.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In accordance with an aspect, a present method relates to determining a location of a device based on measurements from multiple RATs. The described aspects include determining, at a first device, one or more RTT measurements based on one or more signals communicated with a second device over a first RAT. The described aspects further include determining, at the first device, one or more angle measurements based on one or more signals communicated with the second device over a second RAT. The described aspects further include determining a location of the first device in relation to the second device based on the one or more RTT measurements and the one or more angle measurements.

In another aspect, a present computer-readable medium storing computer executable code relates to determining a location of a device based on measurements from multiple RATs. The described aspects include code for determining, at a first device, one or more RTT measurements based on one or more signals communicated with a second device over a first RAT. The described aspects further include code for determining, at the first device, one or more angle measurements based on one or more signals communicated with the second device over a second RAT. The described aspects further include code for determining a location of the first device in relation to the second device based on the one or more RTT measurements and the one or more angle measurements.

In a further aspect, a present apparatus relates to determining a location of a device based on measurements from multiple RATs. The described aspects include means for determining, at a first device, one or more RTT measurements based on one or more signals communicated with a second device over a first RAT. The described aspects further include means for determining, at the first device, one or more angle measurements based on one or more signals communicated with the second device over a second RAT. The described aspects further include means for determining a location of the first device in relation to the second device based on the one or more RTT measurements and the one or more angle measurements.

In another aspect, a present apparatus relates to determining a location of a device based on measurements from multiple RATs. The described aspects include a transceiver, a memory configured to store data, and one or more processors communicatively coupled with the transceiver and the memory, wherein the one or more processors and the memory are configured to determine, at a first device, one or more RTT measurements based on one or more signals communicated with a second device over a first RAT. The described aspects further include determine, at the first device, one or more angle measurements based on one or more signals communicated with the second device over a second RAT. The described aspects further include determine a location of the first device in relation to the second device based on the one or more RTT measurements and the one or more angle measurements.

Various aspects and features of the disclosure are described in further detail below with reference to various examples thereof as shown in the accompanying drawings. While the present disclosure is described below with reference to various examples, it should be understood that the present disclosure is not limited thereto. Those of ordinary skill in the art having access to the teachings herein will recognize additional implementations, modifications, and examples, as well as other fields of use, which are within the scope of the present disclosure as described herein, and with respect to which the present disclosure may be of significant utility.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout, where dashed lines may indicate optional components or actions, and wherein:

FIG. 1 is a conceptual diagram illustrating an example of a wireless local area network (WLAN) deployment.

FIGS. 2A and 2B are schematic diagrams of a communication network including aspects of a wireless device and a network entity, respectively, that may be configured for determining a location of device based on measurements from multiple RATs in accordance with various aspects of the present disclosure.

FIG. 3 is a diagram illustrating an example of two devices communicating measurement information across multiple RATs to determine their respective locations in accordance with various aspects of the present disclosure.

FIG. 4A is a diagram illustrating an example of calculating the two-dimensional (2D) location of a device based on the radial distance and azimuth in accordance with various aspects of the present disclosure.

FIG. 4B is a diagram illustrating an example of calculating the three-dimensional (3D) location of a device based on the radial distance and azimuth in accordance with various aspects of the present disclosure.

FIGS. 5 and 6 are flow diagrams illustrating example methods of determining the location of a device based on measurements from multiple RATs in accordance with various aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known components are shown in block diagram form in order to avoid obscuring such concepts. In an aspect, the term “component” as used herein may be one of the parts that make up a system, may be hardware or software, and may be divided into other components.

The present aspects generally relate to determining the location of a device based on measurements from multiple RATs. In an aspect, for example, in some wireless communication networks, a device may determine its location in relation to other devices in the same network. For example, IEEE 802.11REVmc, a WLAN standard, provides a way for two devices to exchange Fine Timing Measurement (FTM) frames to measure the Round Trip Time (RTT) between the two devices, where the RTT measurements can be used to estimate the range or distance between the two devices. When using RTT measurements, however, a WLAN device requires the information from at least three other WLAN devices with known two dimensional (2D) locations to compute or determine its own 2D location. On the other hand, a Bluetooth (BT) device can use either Angle-of-Arrival (AoA) or Angle-of-Departure (AoD) information for estimating the azimuth between itself and another BT device. Similar to WLAN devices, a BT device requires information from three other closely placed peer BT devices with known 2D locations for the BT device to compute or determine its own 2D location. The data or information exchange between the WLAN or BT device and the other three devices are typically done in sequence. The data or information exchange may take an extended amount of time during which the device may have changed locations resulting in inaccurate location determinations. Moreover, in certain instances, the device may not be situated near three other devices (either WLAN or BT configured), and so, may not have the necessary information to determine its location.

Accordingly, in some aspects, the present methods and apparatuses may provide an efficient solution, as compared to current solutions, by determining the location of a device based on measurements from multiple RATs from a single device. In other words, in the present aspects, a device may be capable of determining its location based on measurements from only one other device. As such, the present aspects provide one or more mechanisms for receiving, at a first device, one or more RTT measurements from a second device over a first RAT; receiving, at the first device, one or more angle measurements from the second device over a second RAT; and determining a location of the first device in relation to the second device based on the one or more RTT measurements and the one or more angle measurements.

Aspects of the disclosure are provided in the following description and related drawings directed to specific disclosed aspects. Alternate aspects may be devised without departing from the scope of the disclosure. Additionally, well-known aspects of the disclosure may not be described in detail or may be omitted so as not to obscure more relevant details. Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

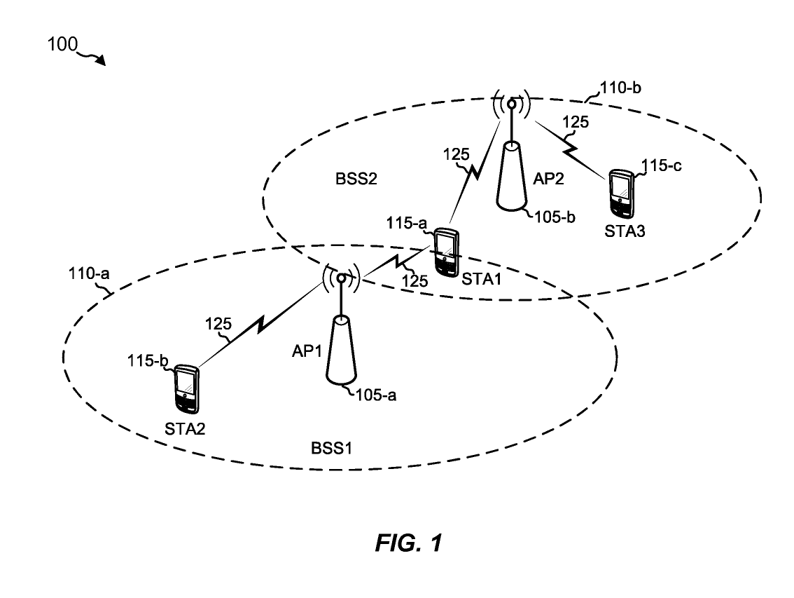

FIG. 1 is a wireless communication system 100 illustrating an example of a wireless local area network (WLAN) deployment in connection with various techniques described herein. The WLAN deployment may include one or more access points (APs) and one or more mobile stations (STAs) associated with a respective AP. In this example, there are only two APs deployed for illustrative purposes: AP1 105-a in basic service set 1 (BSS1) and AP2 105-b in BSS2. AP1 105-a is shown having at least two associated STAs (STA1 115-a and STA2 115-b) and coverage area 110-a, while AP2 105-b is shown having at least two associated STAs (STA1 115-a and STA3 115-c) and coverage area 110-b. In the example of FIG. 1, the coverage area of AP1 105-a overlaps part of the coverage area of AP2 105-b such that STA1 115-a is within the overlapping portion of the coverage areas. The number of BSSs, APs, and STAs, and the coverage areas of the APs described in connection with the WLAN deployment of FIG. 1 are provided by way of illustration and not of limitation. Moreover, aspects of the various techniques described herein are at least partially based on the example WLAN deployment of FIG. 1 but need not be so limited.

The APs (e.g., AP1 105-a and AP2 105-b) shown in FIG. 1 are generally fixed terminals that provide backhaul services to STAs within its coverage area or region. In some applications, however, the AP may be a mobile or non-fixed terminal. The STAs (e.g., STA1 115-a, STA2 115-b and STA3 115-c) shown in FIG. 1, which may be fixed, non-fixed, or mobile terminals, utilize the backhaul services of their respective AP to connect to a network, such as the Internet. Examples of an STA include, but are not limited to: a cellular phone, a smart phone, a laptop computer, a desktop computer, a personal digital assistant (PDA), a personal communication system (PCS) device, a personal information manager (PIM), personal navigation device (PND), a global positioning system, a multimedia device, a video device, an audio device, a device for the Internet-of-Things (IoT), or any other suitable wireless apparatus requiring the backhaul services of an AP. An STA may also be referred to by those skilled in the art as: a subscriber station, a mobile unit, a subscriber unit, a wireless unit, a remote unit, a mobile device, a wireless device, a wireless communications device, a remote device, a mobile subscriber station, an access terminal, a mobile terminal, a wireless station, a remote terminal, a handset, a user agent, a mobile client, a client, user equipment (UE), or some other suitable terminology. An AP may also be referred to as: a base station, a base transceiver station, a radio base station, a radio transceiver, a transceiver function, a small cell, or any other suitable terminology. The various concepts described throughout this disclosure are intended to apply to all suitable wireless apparatus regardless of their specific nomenclature.

Each of STA1 115-a, STA2 115-b, and STA3 115-c may be implemented with a protocol stack. The protocol stack can include a physical layer for transmitting and receiving data in accordance with the physical and electrical specifications of the wireless channel, a data link layer for managing access to the wireless channel, a network layer for managing source to destination data transfer, a transport layer for managing transparent transfer of data between end users, and any other layers necessary or desirable for establishing or supporting a connection to a network.

Each of AP1 105-a and AP2 105-b can include software applications and/or circuitry to enable associated STAs to connect to a network via communications links 125. The APs can send frames to their respective STAs and receive frames from their respective STAs to communicate data and/or control information (e.g., signaling).

Each of AP1 105-a and AP2 105-b can establish a communications link 125 with an STA that is within the coverage area of the AP. Communications links 125 can comprise communications channels that can enable both uplink and downlink communications. When connecting to an AP, an STA can first authenticate itself with the AP and then associate itself with the AP. Once associated, a communications link 125 can be established between the AP and the STA such that the AP and the associated STA can exchange frames or messages through a direct communications channel.

While aspects of the present disclosure are described in connection with a WLAN deployment or the use of IEEE 802.11-compliant networks, those skilled in the art will readily appreciate, the various aspects described throughout this disclosure may be extended to other networks employing various standards or protocols including, by way of example, BLUETOOTH® (Bluetooth), HiperLAN (a set of wireless standards, comparable to the IEEE 802.11 standards, used primarily in Europe), and other technologies used in wide area networks (WAN)s, WLANs, personal area networks (PAN)s, or other suitable networks now known or later developed. Thus, the various aspects presented throughout this disclosure for determining a device location may be applicable to any suitable wireless network regardless of the coverage range and the wireless access protocols utilized.

In one aspect, an STA or an AP as shown in FIG. 1 may be capable of determining its own location based on measurements from only one reference device. As such, the present aspects provide one or more mechanisms for determining, at a first device, one or more RTT measurements based on one or more signals communicated with a second device over a first RAT. The one or more signals communicated with the second device may include one or more signals communicated from the first device to the second device, one or more signals communicated from the second device to the first device, or both. As one example, an STA (e.g., the first device) may receive one or more RTT measurements from an AP (e.g., the second device) over a WLAN communications links 125 between the STA and the AP. In this example, the one or more RTT measurements may be calculated by the AP and provided to the STA in a message (e.g., a Bluetooth or WLAN message) sent from the AP to the STA. The STA can then determine the one or more RTT measurements by analyzing the received message and locating the one or more RTT measurements within the message. In another example, the STA (e.g., the first device) may communicate one or more signals with the AP (e.g., the second device) and may calculate the one or more RTT measurements based on the one or more signals communicated with the AP over a first RAT. In this example, the one or more RTT measurements may be calculated locally by the STA (instead of the AP calculating the one or more RTT measurements and providing them to the STA) based on data associated with the exchange of one or more messages between the STA and the AP.

Moreover, the first device may determine one or more angle measurements based on one or more signals communicated with the second device over a second RAT. The one or more signals communicated with the second device may include one or more signals communicated from the first device to the second device, one or more signals communicated from the second device to the first device, or both. For example, the STA that received RTT measurements from the AP may also determine angle measurements from the AP over a Bluetooth (BT) connection, where the AP has both WLAN and Bluetooth capabilities, and the angle measurements were performed using Bluetooth-related signals. As one example, an STA (e.g., the first device) may receive one or more angle measurements from an AP (e.g., the second device) over a BT or WLAN communications link between the STA and the AP. In this example, the one or more angle measurements may be calculated by the AP and provided to the STA in a message (e.g., a BT or WLAN message) sent from the AP to the STA. The message that provides the one or more angle measurements may the same message or a different message than the message that provided the one or more RTT measurements. The STA can then determine the one or more angle measurements by analyzing the received message and locating the one or more angle measurements within the message. In another example, the STA (e.g., the first device) may communicate one or more signals with the AP (e.g., the second device) and may calculate the one or more angle measurements based on the one or more signals communicated with the AP over a BT connection. In this example, the one or more angle measurements may be calculated locally by the STA (instead of the AP calculating the one or more angle measurements and providing them to the STA) based on data associated with the exchange of one or more messages between the STA and the AP.

Finally, the first device may determine its location in relation to the second device based on the one or more RTT measurements and the one or more angle measurements. For example, the STA may determine or calculate its location relative to the AP. In some instances, the position or location of the AP may be known and, consequently, the exact or absolute location of the STA may be therefore determined using this approach. While this example has been presented with respect to an STA and an AP in the WLAN deployment in FIG. 1, a similar approach may be followed between an AP and an STA, or between two STAs.

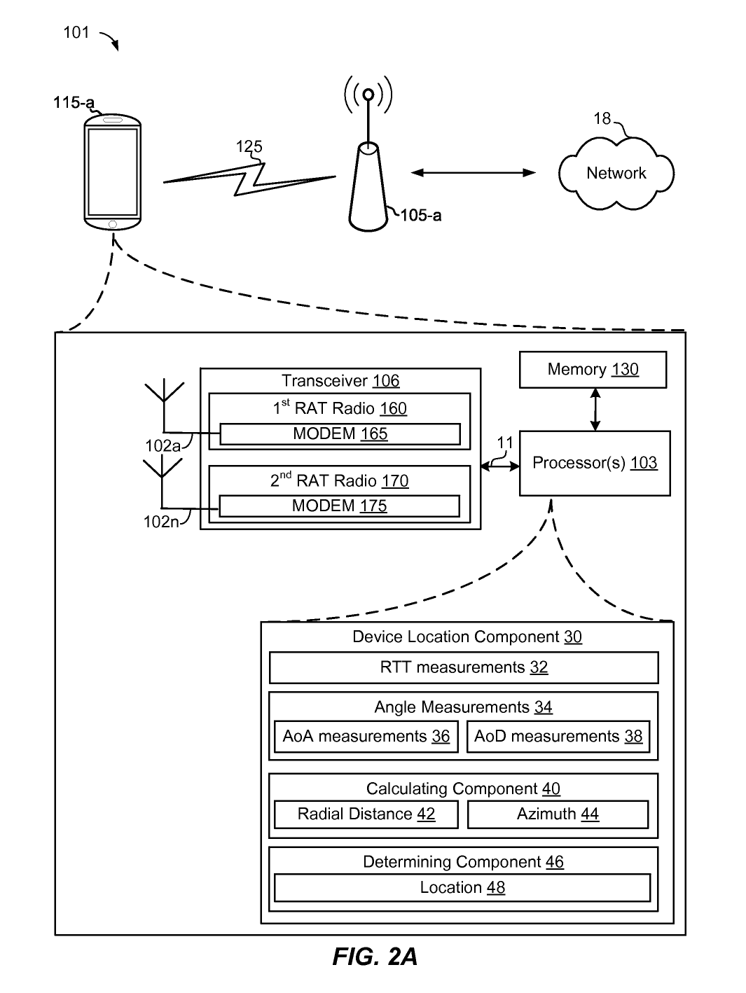

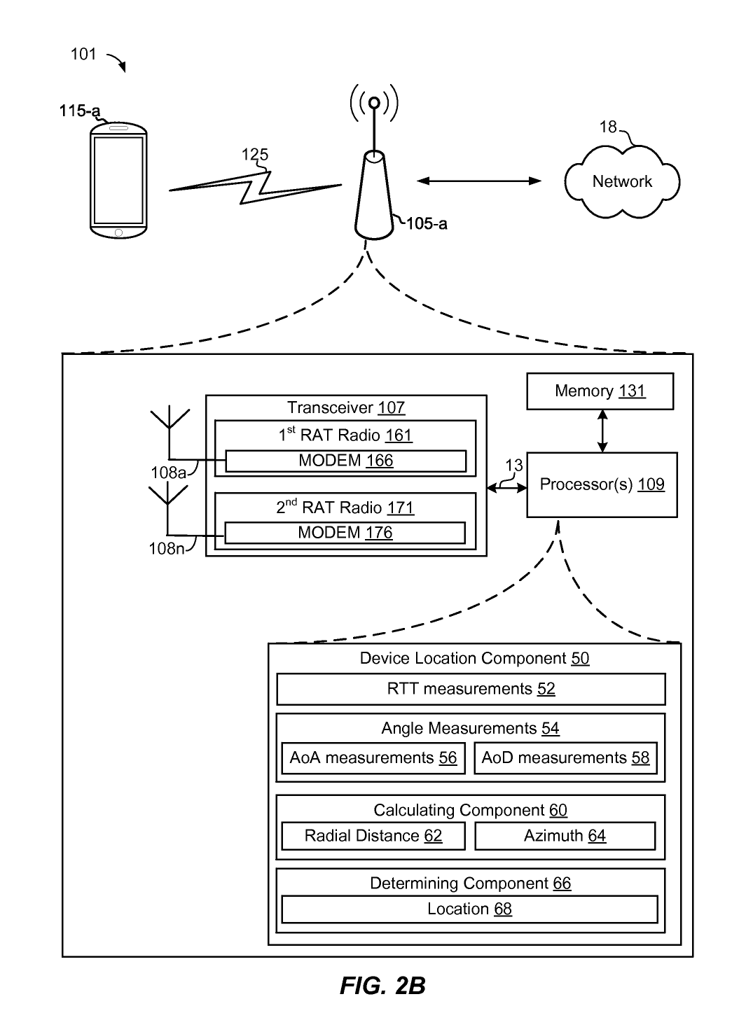

Referring to FIGS. 2A and 2B, in an aspect, a wireless communication system 101 includes at least one wireless device 115-a in communication coverage of at least one AP 105-a, similar to STA 115-a and AP1 105-a of FIG. 1. The wireless device 115-a may communicate with network via AP 105-a. In an example, wireless device 115-a may transmit and/or receive wireless communication to and/or from AP 105-a via one or more communication links 125, which may include an uplink communication channel (or simply uplink channel) and a downlink communication channel (or simply downlink channel), such as but not limited to an uplink data channel and/or downlink data channel. Such wireless communications may include, but are not limited to, data, audio and/or video information. In an aspect, wireless device 115-a and/or AP 105-a may be configured to determine the location of a device based on measurements associated with multiple RATs and with a single reference device. As one example, an AP or a first wireless device may be used to determine the location of a second wireless device. As another example, a wireless device or a first AP may be used to determine the location of a second AP.

Referring to FIG. 2A, in accordance with the present disclosure, wireless device 115-a may include a memory 130, one or more processors 103 and a transceiver 106. The memory, one or more processors 103 and the transceiver 106 may communicate internally via a bus 11. In some examples, the memory 130 and the one or more processors 103 may be part of the same hardware component (e.g., may be part of a same board, module, or integrated circuit). Alternatively, the memory 130 and the one or more processors 103 may be separate components that may act in conjunction with one another. In some aspects, the bus 11 may be a communication system that transfers data between multiple components and subcomponents of the wireless device 115-a. In some examples, the one or more processors 103 may include any one or combination of modem processor, baseband processor, applications processor, central processing unit (CPU), digital signal processor and/or transmit processor. Additionally or alternatively, the one or more processors 103 may include a device location component 30 for carrying out one or more methods or procedures described herein. The device location component 30 may comprise hardware, firmware, and/or software and may be configured as a processor that executes code or perform instructions stored in a memory (e.g., a computer-readable storage medium).

In some examples, the wireless device 115-a may include the memory 130, such as for storing data used herein and/or local versions of applications or device location component 30 and/or one or more of its subcomponents being executed by the one or more processors 103. Memory 130 can include any type of computer-readable medium usable by a computer or processor 103, such as random access memory (RAM), read only memory (ROM), flash memory, tapes, magnetic discs, optical discs, volatile memory, non-volatile memory, and any combination thereof. In an aspect, for example, memory 130 may be a computer-readable storage medium (e.g., a non-transitory medium) that stores computer-executable code. The computer-executable code may define one or more operations or functions of device location component 30 and/or one or more of its subcomponents, and/or data associated therewith. The computer-executable code may define these one or more operations or functions when wireless device 115-a is operating processor 103 to execute device location component 30 and/or one or more of its subcomponents.

In some examples, the wireless device 115-a may further include a transceiver 106 for transmitting and/or receiving one or more data and control signals to/from the network via AP 105-a. The transceiver 106 may comprise hardware, firmware, and/or software and may be configured to execute code or perform instructions stored in a memory (e.g., a computer-readable storage medium). The transceiver 106 may include a 1^{st} RAT radio 160 comprising a modem 165, and a 2^{nd} RAT radio 170 comprising a modem 175. In an aspect, a wireless local area network (WLAN) may correspond to the 1^{st} RAT (e.g., WLAN radio using IEEE 802.11 communication techniques), and a short distance communication protocol may correspond to the 2^{nd} RAT (e.g., Bluetooth radio). In another aspect, 2^{nd} RAT radio 170 with modem 175 may correspond to any other form of short range communications protocol. The 1^{st} RAT radio 160 and 2^{nd} RAT radio 170 may utilize one or more antennas 102a-n for transmitting signals to and receiving signals from the AP 105-a. In a blended radio environment such as system 101, different RATs may make use of different channels at different times.

Similarly, with regard to FIG. 2B, AP 105-a may include a memory 131, one or more processors 109 and a transceiver 107. Memory 131, one or more processors 109 and a transceiver 107 may operate in the same and/or similar manner to memory 130, one or more processors 103 and a transceiver 106 of wireless device 115-a described in FIG. 2A. Furthermore, memory 131, one or more processors 109 and a transceiver 107 may operate the same and/or similar components including, but not limited to a 1^{st} RAT radio 161 with modem 166, a 2^{nd} RAT radio 171 with modem 176, and antennas 108a-n. Moreover, memory 131, one or more processors 109 and the transceiver 107 may communicate internally via a bus 13. Furthermore, memory 131, one or more processors 109 and the transceiver 107 communicating internally via a bus 13 may be configured to determine the location of a device based on measurements associated with multiple RATs and with a single reference device.

Referring back to FIG. 2A, as noted above, in an aspect, system 101 may include wireless device 115-a, and which wireless device 115-a may include a device location component 30 having a calculating component 40 and a determining component 46. For example, wireless device 115-a may be configured for determining one or more RTT measurements 32 based on one or more signals communicated with a second device, such as AP 105-a, over a first RAT via one or more antennas 102a-n and 1^{st} RAT radio 160 with modem 165. The RTT measurements 32 may correspond to WLAN RTT measurements made from the exchange of WLAN Fine Timing Measurement (FTM) frames between wireless device 115-a and AP 105-a via communication link 125. The RTT measurements 32 may estimate the range or distance between two devices communicating the FTM frames. In this instance, the RTT measurements 32 may estimate the range or distance between wireless device 115-a and AP 105-a. In an aspect, the wireless device 115-a may determine the one or more RTT measurements 32 by either receiving one or more RTT measurements 32 from a second device, such as AP 105-a, over a first RAT, or may calculate one or more RTT measurements 32 based on one or more signals communicated with the second device, such as AP 105-a. If the calculations are performed locally at the wireless device 115-a (e.g., by calculating component 40), then wireless device 115-a and AP 105-a may follow the WLAN RTT standard (IEEE 802.11REVmc) and exchange WLAN signals (FTM frames and acknowledgement (ACK) signals). In another example, wireless device 115-a may be configured for transmitting an RTT measurement request. In some instances, the FTM frames may correspond with the RTT measurement request. As such, the RTT measurements 32 are received in response to the RTT measurement request. Similarly, wireless device 115-a and AP 105-a may follow the WLAN RTT standard (IEEE 802.11REVmc) and exchange WLAN signals (FTM frames and acknowledgement (ACK) signals).

Additionally, wireless device 115-a may be configured for determine one or more angle measurements 34 based on one or more signals communicated with the second device (e.g., AP 105-a) over a second RAT via one or more antennas 102a-n and 2^{nd} RAT radio 170 (e.g., a Bluetooth radio) with modem 175. The angle measurements 34 may include Angle of Arrival (AoA) measurements 36 and/or Angle of Departure (AoD) measurements 38. The AoA measurements 36 may correspond to measurements for determining the direction of propagation of a radio-frequency wave incident arriving on an antenna array. If the AoA measurements 36 are to be performed by AP 105-a, then the antennas of AP 105-a (e.g., antennas 108a-n of FIG. 2B) may receive signals transmitted from one or more antennas of wireless device 115-a (e.g., antennas 102a-n), and perform AoA measurements 36 based on the received signals. In another aspect, if AoA measurements 36 are to be performed by wireless device 115-a, then the multiple antennas of wireless device 115-a (e.g., antennas 102a-n) may receive signals transmitted from one or more antennas of AP 105-a (e.g., antennas 108a-n of FIG. 2B), and perform AoA measurements 36 based on the received signals. The AoD measurements 38 may correspond to measurements for determining the direction of propagation of a radio-frequency wave incident departing from one or more antennas. If the AoD measurements 38 are to be performed by AP 105-a, then AP 105-a may receive signals using one or more antennas (e.g., antennas 108a-n of FIG. 2B) from multiple antennas of the wireless device 115-a (e.g., antennas 102a-n). If AoD measurements 38 are to be performed by wireless device 115-a, the wireless device 115-a may receive signals using one or more antennas (e.g., antennas 102a-n) from multiple antennas of the AP 105-a (e.g., antennas 108a-n of FIG. 2B). The AoA measurements 36 and the AoD measurements 38 may correspond to Bluetooth AoA and AoD measurements, respectively. In an aspect, the RTT measurements 32 and angle measurements 34 may be sent to device location component 30 in response to being received by the one or more antennas 102a-n. In another aspect, the RTT measurements 32 and angle measurements 34 may also be placed in memory 130. In another example, wireless device 115-a may be configured for transmitting an angle measurement request. As such, the angle measurements 34 are received in response to the angle measurement request. In certain instances, if AP 105-a performs the AoA measurements 36 and/or the AoD measurements 38, in response to an angle measurement request from wireless device 115-a, then AP 105-a may transmit the AoA measurements 36 and/or the AoD measurements 38 to wireless device 115-a. In another instance, if wireless device 115-a performs the AoA measurements 36 and/or the AoD measurements 38, then wireless device 115-a may transmit the angle measurement request to AP 105-a, so that AP 105-a may transmit one or more signals for wireless device 115-a to perform AoA measurements 36 on. Moreover, wireless device 115-a may perform AoD measurements 38 on the angle measurement request transmitted.

Further, the calculating component 40 may be configured for calculating radial distance 42 and azimuth 44 based on the one or more RTT and angle measurements. In an aspect, calculating component 40 may be configured to calculate the radial distance 42 from the wireless device 115-a to the AP 105-a based on the one or more RTT measurements 32. The radial distance 42 may correspond to the radius of a circle/sphere in which wireless device 115-a is configured as the center of the circle/sphere. Based on the radial distance 42, device location component 30 may establish that the second device (AP 105-a) is located at any point along the circumference of circle/sphere. In another aspect, the calculating component 40 may be configured to calculate the azimuth 44 between the wireless device 115-a and the AP 105-a based on one or more angle measurements 34. The azimuth 44 corresponds to the angle that signals either arrive at an antenna or depart from the antenna. Based on the azimuth 44, a device (e.g., wireless device 115-a) may determine the direction of the other device (e.g., AP 105-a).

The determining component 46 may be configured for determining the location 48 of the wireless device 115-a in relation to the AP 105-a based on the one or more RTT measurements 32 and the one or more angle measurements 34. In a further aspect, determining component 46 may be configured to determine the location of wireless device 115-a in relation to AP 105-a based on the radial distance 42 and the azimuth 44. Depending on the amount of information available, wireless device 115-a may determine either the 2D location, three-dimensional (3D) location, or the absolute location. For example, if wireless device 115-a determine one or more AoA measurements 36 and one or more AoD measurements 38 based on one or more signals communicated with the AP 105-a, then wireless device 115-a may configure determining component 46 to determine the 3D location based on the one or more RTT measurements 32, the one or more AoA measurements 36, and the one or more AoD measurements 38. Moreover, wireless device 115-a may determine whether the location coordinates of AP 105-a are known or available. For example, AP 105-a may correspond to an access point or base station with a fixed point in which the location coordinates of the fixed point is programmed into the AP 105-a and/or network 18. As such, if the location coordinates of AP 105-a are known then wireless device 115-a may identify an absolute location using the location coordinates. In another instance, the location of the AP 105-a may not be known and only one of the AoA measurements 36 and AoD measurements 38 were received. As such, wireless device 115-a may execute device location component 30 and/or determining component 46 to determine the 2D location in relation to AP 105-a. Moreover, determining component 46 may be configured to determine whether the RTT measurements 32 and the angle measurements 34 are received simultaneously or within a predetermined period of time. If determining component 46 determines that the RTT measurements 32 and the angle measurements 34 are not received simultaneously or within a predetermined period of time, then determining component 46 may configured wireless device 115-a to request the RTT measurements 32 and the angle measurements 34 again.

In an aspect, wireless device 115-a may correspond to a first device while AP 105-a may correspond to a reference device. A reference device may correspond to the device in communication with the device that is configured to determine its location. For example, in FIG. 1, STA 115-a corresponds to the wireless device while either AP1 105-a and AP2 105-b may correspond to the reference device. STA 115-a may determine its 2D-location in relation to the reference device (e.g., either AP1 105-a and AP2 105-b). In this aspect, wireless device 115-a may be configured to determine its device location, as explained above. In another aspect, wireless device 115-a may correspond to the reference device, and so, wireless device 115-a may determine the device location of AP 105-a, or any other device (e.g., other mobile devices). As such, wireless device 115-a may determine a location 48 of the AP 105-a in relation to the wireless device 115-a based on the one or more RTT measurements 32 and the one or more angle measurements 34. Wireless device 115-a may then determine whether location coordinates of the wireless device 115-a are known, and identify an absolute location of the AP 105-a in response to a determination that the location coordinates of the wireless device 115-a are known.

Referring back to FIG. 2B, in an aspect, AP 105-a may include a device location component 50 having a calculating component 60 and a determining component 70. For example, AP 105-a may be configured for receiving one or more RTT measurements 52 from a second device, such as wireless device 115-a, over a first RAT via one or more antennas 108a-n and 1^{st} RAT radio 161 with modem 166. Additionally, AP 105-a may be configured for determining one or more angle measurements 54 from the second device (e.g., wireless device 115-a) over a second RAT via one or more antennas 108a-n and 2^{nd} RAT radio 171 with modem 176.

Further, the calculating component 60 may be configured for calculating radial distance 62 and azimuth 64 based on the one or more RTT and angle measurements. In an aspect, calculating component 60 may be configured to calculate the radial distance 62 from the AP 105-a to the wireless device 115-a based on the one or more RTT measurements 52. The determining component 66 may include means for determining the location 68 of the AP 105-a in relation to the wireless device 115-a based on the one or more RTT measurements 52 and the one or more angle measurements 54.

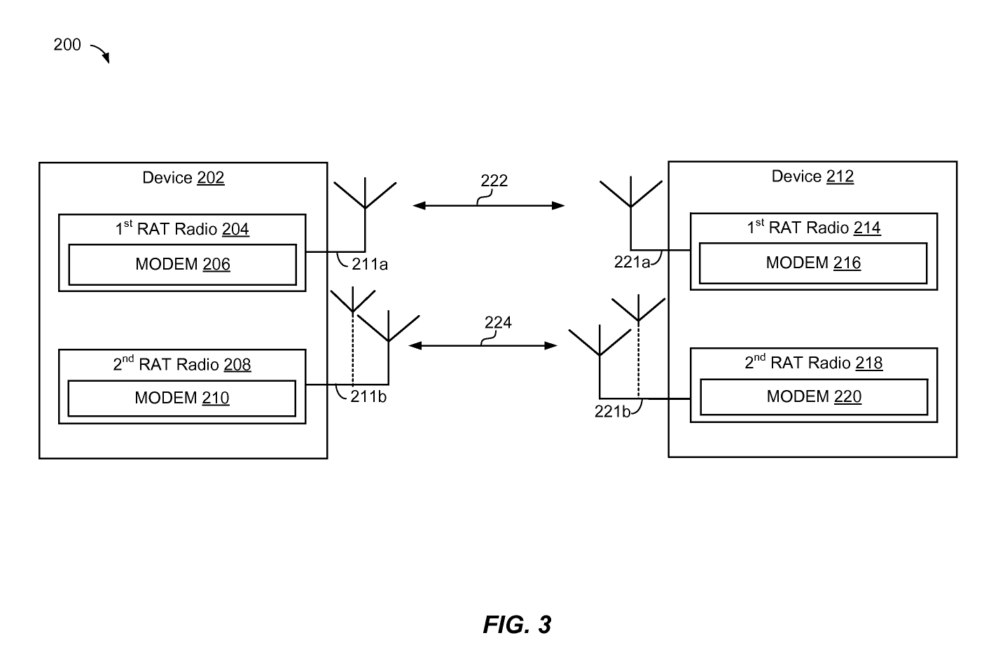

FIG. 3 illustrates a diagram 200 having an example two devices communicating measurement information across multiple RATs to calculate their respective locations. For example, in an aspect, the devices 202 and 212 may correspond to devices of FIGS. 1A and/or 1B (e.g., wireless device 115-a and/or AP 105-a). In another aspect, devices 202 and 212 may correspond to any type of wireless device, such as, but not limited to, a mobile device, access point, base station, etc. With regard to device 202, 1^{st} RAT radio 204 with modem 206 may correspond to a WLAN (e.g., WLAN radio using IEEE 802.11 communication techniques) and 2^{nd} RAT radio 208 with modem 210 may correspond to Bluetooth (e.g., a Bluetooth radio). In another aspect, 2^{nd} RAT radio 208 with modem 210 may correspond to any other form of short range communications protocol. Similarly, with regard to device 212, 1^{st} RAT radio 214 with modem 216 may correspond to WLAN (e.g., WLAN radio) and 2^{nd} RAT radio 218 with modem 220 may correspond to Bluetooth (e.g., a Bluetooth radio). In other implementations of devices 202 and/or 212, one or more alternative RATs may be used in place of WLAN, Bluetooth, or both.

In an aspect, for example, device 202 may communicate with device 212 via both WLAN communication channel 222 and Bluetooth communication channel 224. Device 202 may receive WLAN RTT measurements using antenna 211a from device 212 using antenna 221a via WLAN communication channel 222. Moreover, device 202 may receive Bluetooth angle measurements using antenna 211b from device 212 using antennas 221b via Bluetooth communication channel 224. For example, the angle measurements may include AoA measurements and/or AoD measurements. In this aspect, the one or more AoD measurements are performed on signals transmitted to one or more antennas (e.g., antenna 211b) of device 202 from multiple antennas (e.g., antennas 221b) of device 212 and the one or more AoA measurements are performed on signals transmitted to multiple antennas (e.g., antennas 211b) of the device 202 from one or more antennas (e.g., 221b) of device 212.

In an aspect, device 202 may correspond to a mobile device and device 212 may correspond to a reference device. In this aspect, device 202 may be configured by a device location component, such as device location component 30 (FIG. 2A), to determine the location of device 202 in relation to device 212. In another aspect, device 202 may correspond to a reference device, and device 212 may correspond to a mobile device. Device 202 may be configured to determine the location of device 212, and in some instances, since device 202 corresponds to a reference device, its location coordinates may be known. As such, device 202 may identify the absolute location of device 212. For example, device 202 may determine a location of the device 212 in relation to device 202 based on the one or more RTT measurements and the one or more angle measurements. Further, device 202 may identify an absolute location of device 212 in response to a determination that the location coordinates of the device 202 are known.

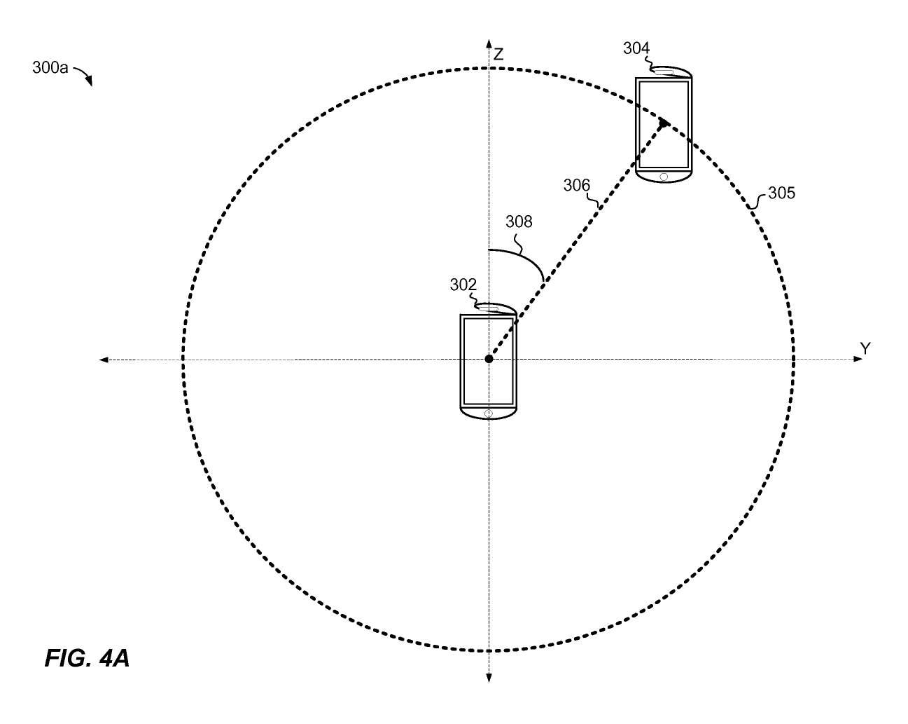

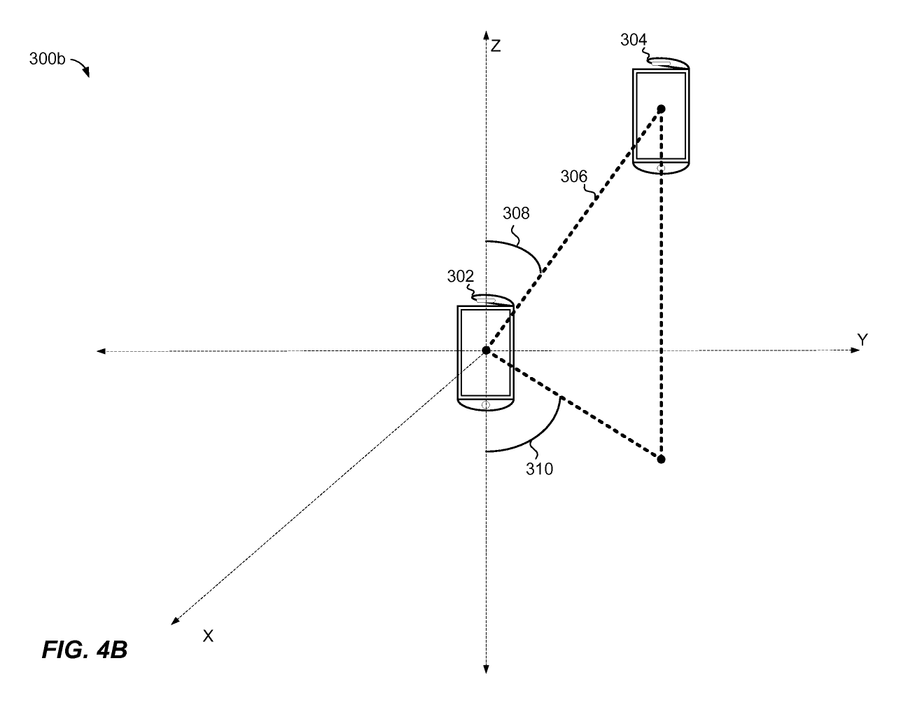

FIG. 4A illustrates an example diagram 300a for calculating the two-dimensional (2D) location of a device based on the radial distance and azimuth as described with respect to FIG. 2A. For example, the devices 302 and 304 may correspond to one or more UEs, network entities, etc., such as wireless device 115-a and/or AP 105-a of FIG. 2A. In an aspect, devices 302 and 304 may exchange communications including one or more RTT measurements and angle measurements. For example, device 304 may correspond to a reference device, and device 302 may be configured to compute its own 2D location. In an aspect, device 302 may receive RTT measurements from device 304 and calculate the radial distance 306 to device 304 based on the RTT measurements. The radial distance 306 may correspond to the radius of circle 305 with device 302 at the center. Circle 305 may indicate that device 304 is located at any point on the circumference of circle 305. Further, device 302 may calculate the azimuth (e.g., theta (θ) 308) based on the angle measurements received corresponding to either the AoA measurement or AoD measurement. For example, device 302 may receive AoA measurements from device 304 and calculate the azimuth based on the received AoA measurements. Moreover, device 302 may receive AoD measurements from device 304 and calculate the azimuth based on the received AoD measurements. Device 302 may calculate theta (θ) 308 based on the angle measurements. Based on calculating the radial distance 306, theta (θ) 308, device 302 may calculate its 2D location in relation to reference device 304.

FIG. 4B illustrates an example diagram 300b for calculating the three-dimensional (3D) location of a device based on the radial distance and azimuth as described with respect to FIG. 2A. For example, the devices 302 and 304 may correspond to one or more UEs, network entities, etc., such as wireless device 115-a and/or AP 105-a of FIG. 2A. In an aspect, devices 302 and 304 may exchange communications including one or more RTT measurements and angle measurements. For example, device 304 may correspond to a reference device, and device 302 may be configured to compute its 3D location. In an aspect, device 302 may receive RTT measurements from device 304 and calculate the radial distance 306 to device 304 based on the RTT measurements. Further, device 302 may calculate the azimuth based on the angle measurements received corresponding to both the AoA measurement and AoD measurement. The AoA measurement may include θ-AoA and φ-AoA. Theta-AoA may correspond to 12 bits representing 0 to 180 degrees with a 0.044 degree resolution. Θ-AoA may correspond to 12 bits representing 0 to 360 degrees with a 0.088 degree resolution. Moreover, the AoD measurement may also include θ-AoD and φ-AoD. Theta-AoD may correspond to 12 bits representing 0 to 180 degrees with a 0.044 degree resolution. Φ-AoD may correspond to 12 bits representing 0 to 360 degrees with a 0.088 degree resolution. Device 302 may calculate theta 308 based on θ-AoA and θ-AoD, and calculate phi 310 based on φ-AoA and φ-AoD. Based on calculating the radial distance 306, θ 308, and φ 310, device 302 may calculate its 3D location in relation to reference device 304.

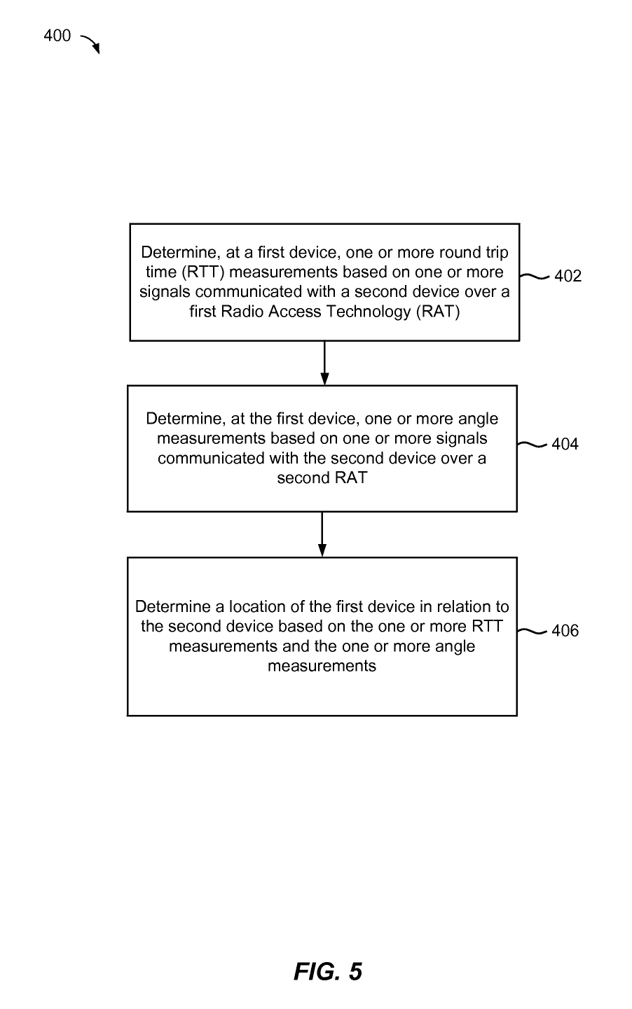

Referring to FIG. 5, an example of one or more operations of an aspect of device location component 30 (FIG. 2A) according to the present apparatus and methods are described with reference to one or more methods and one or more components that may perform the actions of these methods. Although the operations described below are presented in a particular order and/or as being performed by an example component, it should be understood that the ordering of the actions and the components performing the actions may be varied, depending on the implementation. Also, although the device location component 30 is illustrated as having a number of subcomponents, it should be understood that one or more of the illustrated subcomponent may be separate from, but in communication with, the device location component 30 and/or each other. Moreover, it should be understood that the following actions or components described with respect to the device location component 30 and/or its subcomponents may be performed by a specially-programmed processor, a processor executing specially-programmed software or computer-readable media, or by any other combination of a hardware component and/or a software component specially configured for performing the described actions or components.

In an aspect, at block 402, method 400 includes determining, at a first device, one or more round trip time (RTT) measurements based on one or more signals communicated with a second device over a first Radio Access Technology (RAT). In an aspect, for example, wireless device 115-a may execute a transceiver 106 (FIG. 2A) to determine one or more RTT measurements 32 based on one or more signals communicated with a second device (e.g., AP 105-a) over a first RAT (via a first RAT radio 160). In another aspect, block 402 may provide a means for determining, at a first device, one or more RTT measurements based on one or more signals communicated with a second device over a first RAT. For example, the means for determining may correspond to one or more of a wireless device 115-a, transceiver 106, first RAT radio 160, modem 165, antennas 102a-n, and device location component 30.

In an aspect, at block 404, method 400 includes determining, at the first device, one or more angle measurements based on one or more signals communicated with the second device over a second RAT. In an aspect, for example, wireless device 115-a may execute a transceiver 106 (FIG. 2A) to determine one or more angle measurements 34 based on one or more signals communicated with the second device (e.g., AP 105-a) over a second RAT (via a second RAT radio 170). In another aspect, block 404 may provide means for determining, at the first device, one or more angle measurements based on one or more signals communicated with the second device over a second RAT. For example, the means for determining may correspond to one or more of a wireless device 115-a, transceiver 106, first RAT radio 160, modem 165, antennas 102a-n, and device location component 30.

In an aspect, at block 406, method 400 includes determining a location of the first device in relation to the second device based on the one or more RTT measurements and the one or more angle measurements. In an aspect, for example, wireless device 115-a may execute device location component 30 and/or a determining component 46 to determine a location 48 of the first device (e.g., wireless device 115-a) in relation to the second device (e.g., AP 105-a) based on the one or more RTT measurements 32 and the one or more angle measurements 34. In another aspect, block 406 may provide means for determining a location of the first device in relation to the second device based on the one or more RTT measurements and the one or more angle measurements. For example, the means for determining may correspond to one or more of a wireless device 115-a, processor 103, device location component 30, and determining component 46.

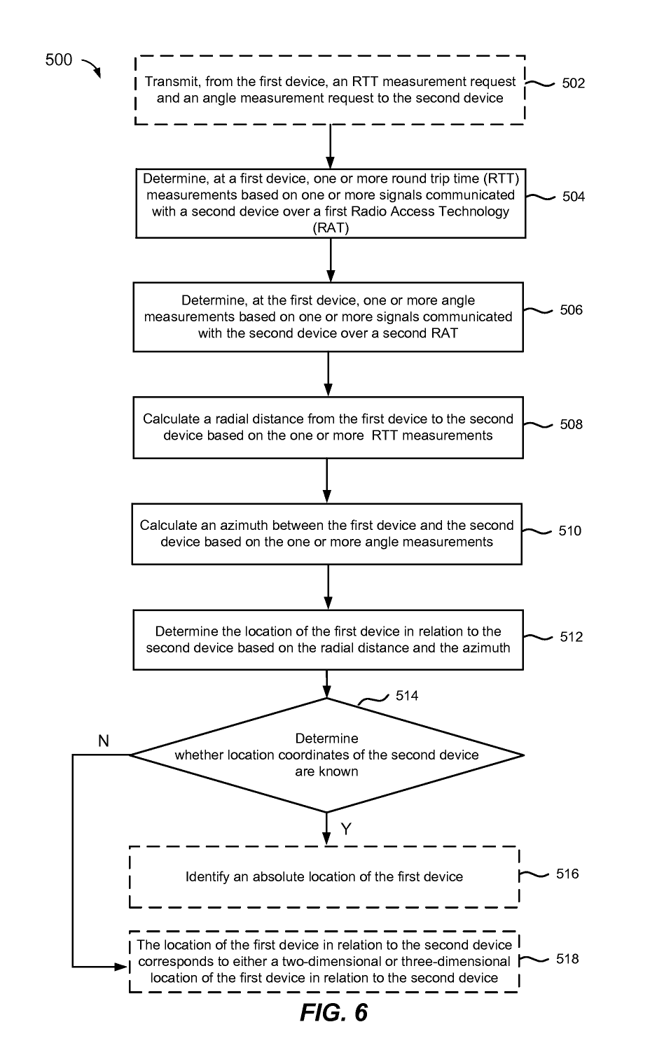

Referring to FIG. 6, an example of one or more operations of an aspect of device location component 30 (FIG. 2A) according to the present apparatus and methods are described with reference to one or more methods and one or more components that may perform the actions of these methods. Although the operations described below are presented in a particular order and/or as being performed by an example component, it should be understood that the ordering of the actions and the components performing the actions may be varied, depending on the implementation. Also, although the device location component 30 is illustrated as having a number of subcomponents, it should be understood that one or more of the illustrated subcomponent may be separate from, but in communication with, the device location component 30 and/or each other. Moreover, it should be understood that the following actions or components described with respect to the device location component 30 and/or its subcomponents may be performed by a specially-programmed processor, a processor executing specially-programmed software or computer-readable media, or by any other combination of a hardware component and/or a software component specially configured for performing the described actions or components.

In an aspect, at block 502, method 500 optionally includes transmitting, from the first device, an RTT measurement request and an angle measurement request to the second device. In an aspect, for example, wireless device 115-a may execute a transceiver 106 (FIG. 2A) (each of which may be implemented by processor 103 executing request transmission instructions stored in memory 130) to transmit an RTT measurement request and an angle measurement request to the second device (e.g., AP 105-a). In an aspect, the RTT measurement request and the angle measurement request may be transmitted separately or together. For example, the RTT measurement request may correspond to FTM frames.

In an aspect, at block 504, method 500 includes determining, at a first device, one or more RTT measurements based on one or more signals communicated with a second device over a first RAT. In an aspect, for example, wireless device 115-a may execute a transceiver 106 (FIG. 2A) (each of which may be implemented by processor 103 executing RTT measurement reception instructions stored in memory 130) to determine one or more RTT measurements 32 based on one or more signals communicated with a second device (e.g., AP 105-a) over a first RAT (via a first RAT radio 160). In an aspect, the RTT measurements may be received in a IEEE 802.11REVmc format (e.g., a WLAN standard).

In an aspect, at block 506, method 500 includes determining, at the first device, one or more angle measurements (e.g., AoA and/or AoD) based on one or more signals communicated with the second device over a second RAT. In an aspect, for example, wireless device 115-a may execute a transceiver 106 (FIG. 2A) (each of which may be implemented by processor 103 executing angle measurement reception instructions stored in memory 130) to determine one or more angle measurements 34 based on one or more signals communicated with the second device (e.g., AP 105-a) over a second RAT (via a second RAT radio 170). In an aspect, the one or more angle measurements (e.g., AoA and/or AoD) may be received via Bluetooth, and may include values (e.g., in degrees) for the either the AoA and/or AoD.

In an aspect, at block 508, method 500 includes calculating a radial distance from the first device to the second device based on the one or more RTT measurements. In an aspect, for example, wireless device 115-a may execute device location component 30 (FIG. 2A) and/or a calculating component 40 (each of which may be implemented by processor 103 executing radial distance calculation instructions stored in memory 130) to calculate a radial distance 42 from the first device (e.g., wireless device 115-a) to the second device (e.g., AP 105-a) based on the one or more RTT measurements 32. The radial distance 42 may correspond to the radius of a circle/sphere in which wireless device 115-a is configured as the center of the circle/sphere. Based on the radial distance 42, device location component 30 may establish that the second device (AP 105-a) is located at any point along the circumference of circle/sphere.

In an aspect, at block 510, method 500 includes calculating an azimuth between the first device and the second device based on the one or more angle measurements. In an aspect, for example, wireless device 115-a may execute device location component 30 (FIG. 2A) and/or a calculating component 40 (each of which may be implemented by processor 103 executing azimuth calculation instructions stored in memory 130) to calculate an azimuth 44 between the first device (e.g., wireless device 115-a) and the second device (e.g., AP 105-a) based on the one or more angle measurements 34. The azimuth 44 corresponds to the angle that signals either arrive at an antenna or depart from the antenna. Based on the azimuth 44, a device (e.g., wireless device 115-a) may determine the direction of the other device (e.g., AP 105-a).

In an aspect, at block 512, method 500 includes determining the location of the first device in relation to the second device based on the radial distance and the azimuth. In an aspect, for example, wireless device 115-a may execute device location component 30 and/or a determining component 46 (each of which may be implemented by processor 103 executing location determination instructions stored in memory 130) to determining the location 48 of the first device (e.g., wireless device 115-a) in relation to the second device (AP 105-a) based on the radial distance 42 and the azimuth 44. For example, wireless device 115-a may use the azimuth 44 to determine the direction of the second device and the radial distance 42 to establish that the second device is located at any point along the circumference of circle/sphere. Therefore, the point that the azimuth 44 intersects with the circle/sphere is the location of the second device in relation to the wireless device 115-a.

In an aspect, at block 514, method 500 includes determining whether location coordinates of the second device are known. In an aspect, for example, wireless device 115-a may execute device location component 30 and/or a determining component 46 (each of which may be implemented by processor 103 executing location coordinate instructions stored in memory 130) to determine whether location coordinates of the second device (e.g., AP 105-a) are known. In an aspect, the location coordinates may correspond to either two-dimensional location or three-dimensional location represented in units (e.g., meters, feet, latitude and longitude, etc.). If device location component 30 and/or a determining component 46 determine that location coordinates of the second device (e.g., AP 105-a) are known, then method 500 may proceed to block 516. However, if device location component 30 and/or a determining component 46 determine that location coordinates of the second device (e.g., AP 105-a) are unknown, then method 500 may proceed to block 518.

In aspect, at block 516, method 500 optionally includes identifying an absolute location of the first device. In an aspect, for example, wireless device 115-a may execute device location component 30 and/or a determining component 46 (each of which may be implemented by processor 103 executing absolute location identification instructions stored in memory 130) to identify an absolute location of the first device. For example, since the location coordinates of the second device are known, the location of the first device in relation to the second device are known may act as an offset from the location coordinates of the second device to establish the absolute location of the first device.

In aspect, at block 518, method 500 includes that the location of the first device in relation to the second device corresponds to either a two-dimensional or three-dimensional location of the first device in relation to the second device. In an aspect, for example, wireless device 115-a may execute device location component 30 and/or a determining component 46 to establish that the location of the first device in relation to the second device corresponds to either a two-dimensional or three-dimensional location of the first device in relation to the second device. In this aspect, if both AoA measurements 36 and AoD measurements 38 are received by wireless device 115-a, then wireless device 115-a may determine establish that the first device in relation to the second device corresponds to a three-dimensional location of the first device in relation to the second device. Otherwise, if only one of the AoA measurements 36 and AoD measurements 38 are received by wireless device 115-a, then wireless device 115-a may determine establish that the first device in relation to the second device corresponds to a two-dimensional location of the first device in relation to the second device.

In some aspects, an apparatus or any component of an apparatus may be configured to (or operable to or adapted to) provide functionality as taught herein. This may be achieved, for example: by manufacturing (e.g., fabricating) the apparatus or component so that it will provide the functionality; by programming the apparatus or component so that it will provide the functionality; or through the use of some other suitable implementation technique. As one example, an integrated circuit may be fabricated to provide the requisite functionality. As another example, an integrated circuit may be fabricated to support the requisite functionality and then configured (e.g., via programming) to provide the requisite functionality. As yet another example, a processor circuit may execute code to provide the requisite functionality.

It should be understood that any reference to an element herein using a designation such as “first,” “second,” and so forth does not generally limit the quantity or order of those elements. Rather, these designations may be used herein as a convenient method of distinguishing between two or more elements or instances of an element. Thus, a reference to first and second elements does not mean that only two elements may be employed there or that the first element must precede the second element in some manner. Also, unless stated otherwise a set of elements may comprise one or more elements. In addition, terminology of the form “at least one of A, B, or C” or “one or more of A, B, or C” or “at least one of the group consisting of A, B, and C” used in the description or the claims means “A or B or C or any combination of these elements.” For example, this terminology may include A, or B, or C, or A and B, or A and C, or A and B and C, or 2A, or 2B, or 2C, and so on.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The methods, sequences and/or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

Accordingly, an aspect of the disclosure can include a computer readable medium embodying a method for dynamic bandwidth management for transmissions in unlicensed spectrum. Accordingly, the disclosure is not limited to the illustrated examples.

While the foregoing disclosure shows illustrative aspects, it should be noted that various changes and modifications could be made herein without departing from the scope of the disclosure as defined by the appended claims. The functions, steps and/or actions of the method claims in accordance with the aspects of the disclosure described herein need not be performed in any particular order. Furthermore, although certain aspects may be described or claimed in the singular, the plural is contemplated unless limitation to the singular is explicitly stated.

What is claimed is:

1. A method for wireless communication, comprising:
determining, at a first device, one or more round trip time (RTT) measurements based on one or more signals communicated with a second device over a first Radio Access Technology (RAT);
determining, at the first device, one or more angle measurements based on one or more signals communicated with the second device over a second RAT; and
determining a location of the first device in relation to the second device based on the one or more RTT measurements and the one or more angle measurements.

2. The method of claim 1, wherein determining the location of the first device comprises:
calculating a radial distance from the first device to the second device based on the one or more RTT measurements;
calculating an azimuth between the first device and the second device based on the one or more angle measurements; and
determining the location of the first device in relation to the second device based on the radial distance and the azimuth.

3. The method of claim 1, wherein determining, at the first device, the one or more angle measurements based on one or more signals communicated with the second device over the second RAT comprises determining one or more angle of departure (AoD) measurements or one or more angle of arrival (AoA) measurements.

4. An apparatus for wireless communication, comprising:
means for determining, at a first device, one or more round trip time (RTT) measurements based on one or more signals communicated with a second device over a first Radio Access Technology (RAT);
means for determining, at the first device, one or more angle measurements based on one or more signals communicated with the second device over a second RAT; and
means for determining a location of the first device in relation to the second device based on the one or more RTT measurements and the one or more angle measurements.

5. An apparatus for wireless communication, comprising:
a memory configured to store data; and
one or more processors communicatively coupled with the memory, wherein the one or more processors and the memory are configured to:
determine, at a first device, one or more round trip time (RTT) measurements based on one or more signals communicated with a second device over a first Radio Access Technology (RAT);
determine, at the first device, one or more angle measurements based on one or more signals communicated with the second device over a second RAT; and
determine a location of the first device in relation to the second device based on the one or more RTT measurements and the one or more angle measurements.

6. The apparatus of claim 5, wherein the one or more processors and the memory are further configured to:
calculate a radial distance from the first device to the second device based on the one or more RTT measurements;
calculate an azimuth between the first device and the second device based on the one or more angle measurements; and
determine the location of the first device in relation to the second device based on the radial distance and the azimuth.

7. The apparatus of claim 5, wherein the one or more processors and the memory are further configured to determine one or more angle of departure (AoD) measurements or one or more angle of arrival (AoA) measurements.

8. The apparatus of claim 7, wherein the one or more AoD measurements are performed by the first device on signals transmitted to one or more antennas of the first device from multiple antennas of the second device and the one or more AoA measurements are performed by the first device on signals transmitted to multiple antennas of the first device from one or more antennas of the second device.

9. The apparatus of claim 5, wherein the one or more processors and the memory are further configured to receive, at the first device, one or more angle measurements from the second device over the second RAT, or calculate, at the first device, one or more angle measurements based on one or more signals received from the second device over the second RAT.

10. The apparatus of claim 5, wherein the one or more processors and the memory are further configured to receive, at the first device, the one or more RTT measurements from the second device over the first RAT or calculate, at the first device, the one or more RTT measurements based on one or more signals received from the second device over the second RAT.

11. The apparatus of claim 5, wherein the one or more processors and the memory are further configured to:
receive one or more AoD measurements and one or more AoA measurements from the second device, and
determine a three-dimensional location of the first device based on the one or more RTT measurements, the one or more AoD measurements, and the one or more AoA measurements.

12. The apparatus of claim 5, wherein the one or more processors and the memory are further configured to receive the one or more RTT measurements and determine the one or more angle measurements simultaneously or within a predetermined period of time.

13. The apparatus of claim 5, wherein the first RAT corresponds to a Wireless Local Area Network (WLAN) technology and the second RAT corresponds to Bluetooth technology.

14. The apparatus of claim 5, wherein the one or more processors and the memory are further configured to:
determine whether location coordinates of the second device are known; and
identify an absolute location of the first device in response to a determination that the location coordinates of the second device are known, based on the location coordinates of the second device, the one or more RTT measurements, and the one or more angle measurements.

15. The apparatus of claim 5, wherein the one or more processors and the memory are further configured to:
determine whether location coordinates of the second device are known; and
identify a relative location of the first device, in response to a determination that the location coordinates of the second device are not known, based on the one or more RTT measurements and the one or more angle measurements.

16. The apparatus of claim 5, wherein the one or more processors and the memory are further configured to transmit, from the first device, an RTT measurement request and an angle measurement request to the second device, wherein the one or more RTT measurements are received in response to the RTT measurement request and the one or more angle measurements are received in response to the angle measurement request.

17. The apparatus of claim 5, wherein the first device corresponds to a mobile device and the second device corresponds to a reference device.

18. The apparatus of claim 5, wherein the one or more processors and the memory are further configured to:
determine a location of the second device in relation to the first device based on the one or more RTT measurements and the one or more angle measurements;
determine whether location coordinates of the first device are known; and
identify an absolute location of the second device in response to a determination that the location coordinates of the first device are known.

19. The apparatus of claim 18, wherein the first device corresponds to a reference device and the second device corresponds to a mobile device.

20. The apparatus of claim 5, further comprising:
a transceiver coupled with the one or more processors,
wherein the transceiver is configured to receive the one or more RTT measurements and the one or more angle measurements, and
wherein the apparatus corresponds to a mobile device.
